(19) United States
(12) Patent Application Publication
(10) Pub. No.: US 2022/0156699 A1
(43) Pub. Date: May 19, 2022

(54) SYSTEM FOR AND METHOD OF LEAD GENERATION

(71) Applicant: SAILE, LLC, Harrisonville, MO (US)

(72) Inventors: Nicholas Joseph Smith, Kansas City, MO (US); Clive Cadogan, Chaguanas (TT)

(21) Appl. No.: 17/145,074

(22) Filed: Jan. 8, 2021

Related U.S. Application Data
(60) Provisional application No. 63/041,486, filed on Jun. 19, 2020.

(51) Int. Cl. G06Q 10/10; G06N 3/08; G06Q 30/02; H04L 12/58; G06F 40/56

(52) U.S. Cl. CPC G06Q 10/107; G06N 3/08; G06F 40/56; G06Q 30/0277; H04L 51/18; G06Q 30/0245

(57) ABSTRACT

A digital labor task system and method is provided. The system and method includes a deployable instance of a natural language understanding model supported by machine learning neural networks with access to one or more addressable email management suite. The system builds a prospect profile, builds a personality profile, generates an account list, generates messaging summary, and engages in a campaign. The system sends marketing materials and ingests and analyzes responses, replaying to incoming responses based on confidence score metrics from the natural language understanding model. The system further identifies actionable opportunities and notifies one or more user of the actionable opportunity.

### CROSS-REFERENCE TO RELATED APPLICATIONS

This application claims priority pursuant to 35 U.S.C. 119(e) to co-pending U.S. Provisional Patent Application Ser. No. 63/041,486, filed Jun. 19, 2020, the entire disclosure of which is incorporated herein by reference.

### FIELD OF THE INVENTION

The present invention relates generally to sales lead generation. More specifically, the present invention is concerned with replicating, multiplying, and advantageously augmenting manual labor digitally, and sales enablement and digital workforce augmentation.

### BACKGROUND

Traditionally, marketing lead generation is a vital but time-consuming task for sales-oriented businesses. Despite the time-consuming nature of lead generation, it is vital for the development of sales leads which drive the revenue of a business. Leads may come from various sources or activities, for example, digitally via the Internet, through personal referral, through telephone calls, through advertisements, and events, among others. Of the various strategies for lead generation, the most-often used by a considerable margin is email (“Marketing Tactics Used by US B2B Marketers to Generate Demand”. eMarketer. 19 Oct. 2015. Retrieved 28 Dec. 2020).

Email marketing presents an opportunity for marketers to reach a large audience with a single click through mass marketing campaigns. However, once responses begin coming in, the process becomes labor intensive as any follow-up correspondence with a prospective lead occurs one at a time. Most sales executives avoid mass emailing of any kind, typically reaching out to prospects one at a time or several at a time, with follow-ups occurring one at a time. The sales executive typically must interact with a potential sales lead through several rounds of back and forth email correspondence before an actionable opportunity arises, such as an agreement to a meeting or a phone call or in some cases, an opportunity for a sale via email. The actionable opportunity is where the sales executive produces much of their value, but much of their time is spent in the initial assessment of interest from the prospective lead and introduction phases prior to the opportunity arising. It would be advantageous to have a system which automates the intermediate communications between initial interest email and the actional opportunity and notifies the sales executives when an actionable opportunity has been identified, allowing sales executives to focus more of their time and efforts on the activities which generate the most value.

The necessity for responding individually to any follow-up emails when attempting to generate actionable opportunities limits the scalability of sales activity. To generate more sales activity from email campaigns, sales executives either need to spend more total time engaging with email traffic or the business must acquire more sales executives. It is difficult for a sales team to generate more labor productivity without altering the time requirements or expanding the labor pool. Therefore, it would be advantageous to provide a system which allows the sales executives to reduce the time spent on less-profitable activities in the lead generation process such as multiple back-and-forth emails and instead devote that time to capitalizing on actionable opportunities, allowing for greater labor productivity. Additionally, it would be advantageous to provide a system which allowed sales executives to scale their productivity without the need for additional time and labor investment.

The structure of sales executive compensation is typically based on generating revenue opportunities with commissions for closing a sale and generating revenue for the business. Thus, there is incentive for sales executives to ignore or otherwise neglect interactions which do not directly impact their commissions. These neglected interactions could however, if properly tended to, generate revenue for the business. Thus, it would be advantageous to provide a system which dynamically attended to such non-actionable opportunities until an actionable opportunity was generated.

Most lead generation solutions are ‘spray and pray’ such that hundreds or even thousands of emails are sent to uncurated lists of email addresses in the hope that one or two may generate value. Oftentimes, these involve individuals other than sales executives or sales managers, oftentimes being associated with individuals in a separate department or a partner company. These individuals can mistake what is a good ‘lead’ for a sales executive and fail to reliably recognize good leads. Because of this, the quality of the leads presented to sales executives is inconsistent and they are oftentimes presented with low-quality leads. Similarly, leads often start outside of a company or at the company's inside sales or marketing departments and go through a series of qualifications before being handed off to a Sales Executive. Once the Sales Executive receives it, the Sales Executive typically has very little vested interest in the lead, often complains about the quality or look for reasons there is not a fit and sometimes discards the lead all together. Therefore, it would be advantageous to have a system which reliably generated and identified actionable opportunities and provided quality leads to sales executives.

Many email management suites have software filters which increasingly identify mass marketing emails as spam. This can lead to a large portion of an email campaign being filtered out prior to ever being received by a prospective lead. Therefore, it would be advantageous to have a system which trained email management suite filters to allow its messaging without marking the messages as spam.

### SUMMARY

The present invention comprises a digital labor task system and method. The system and method includes a deployable instance of a natural language understanding model supported by machine learning neural networks with access to one or more addressable email management suite. The system builds a prospect profile, builds a personality profile, generates an account list, generates messaging summary, and engages in a campaign. The system sends marketing materials and ingests and analyzes responses, replaying to incoming responses based on confidence score metrics from the natural language understanding model. The system further identifies actionable opportunities and notifies one or more user of the actionable opportunity.

The system includes deploying an instance which engages in one or more campaign, such as an email campaign. The system sends out initial emails correspondence to target contacts at prospective companies and monitors for replies from the target contacts. Upon receiving the responses, the system ingests and analyzes each response and assesses an appropriate response utilizing natural language understanding models to generate confidence scores for potential responses. The system then identifies an ideal response for each reply and sends the ideal response. The system repeats this for each conversation, utilizing the model to identify any actionable opportunities during the conversation. Once an actionable opportunity is identified by the model, a user of the system is notified and provided a copy of the entire interaction with the target contact up to that point. Advantageously, the system handles the most labor-intensive aspects of the lead generation process while identifying actionable opportunities, allowing sales executives to focus more of their time and efforts on the activities which generate the most value.

The system also includes generation of a personality profile. Such personality profile includes attributes of responses, such as tone, length, assertiveness, formality, and the like. The generation of a personality profile is performed either manually by inputting desired traits or automatically by allowing the system access to existing communications. In this way, the system is able to mimic the email personality of existing sales executives. Advantageously, this allows for current executives to become scalable, with successful personalities being duplicated on multiple instances without the need for additional time and labor investments.

The system also includes analysis of individual replies and the generation of responses specific to each reply. As this process is automated, these interactions do not detract from commission-generating interactions undertaken by sales executives. Advantageously, the system dynamically attends to all non-actionable opportunities until an actionable opportunity is generated. Moreover, as the system treats all interactions equally and utilizes ever-improving models to identify advantageous responses to replies which are more likely to lead to actionable opportunities, there is a more consistent quality to the generated leads.

The system also includes communication between instances. A first and second instance are configured to communicate with one another in a series of interactions. The instances send and receive actions at a high rate. When received correspondence between the instances are designated as spam by the email management suite, the system marks the correspondence as not spam, identifies it as important, and sends a response. Advantageously, this trains email management suite filters to allow the messaging without marking the messages as spam, increasing the deliverability of all messages originating at the instances.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION

A preferred embodiment of the invention, illustrative of the best mode in which the applicant has contemplated applying the principles, is set forth in the following description and is shown in the drawings and is particularly and distinctly pointed out and set forth in the appended claims.

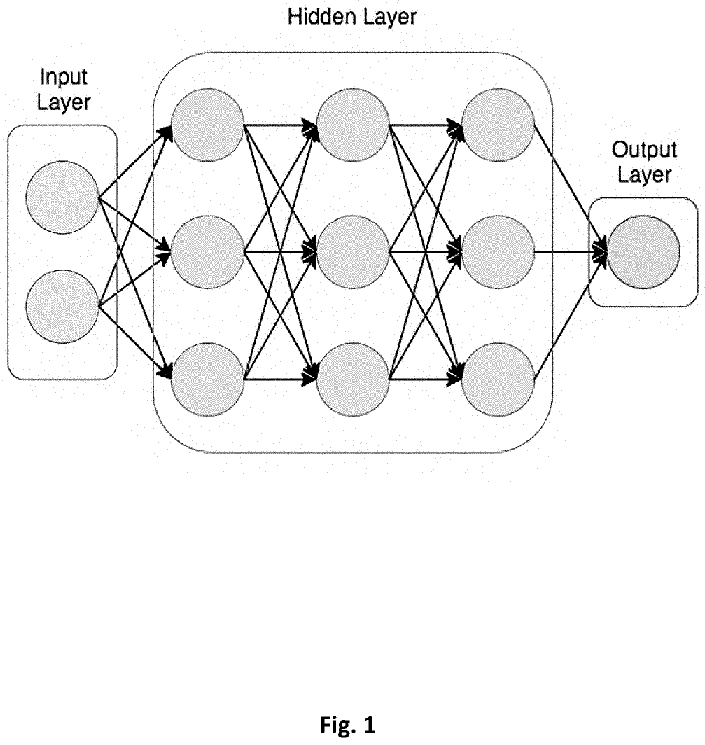

FIG. 1 is a diagram of a neural network according to one embodiment of the present invention.

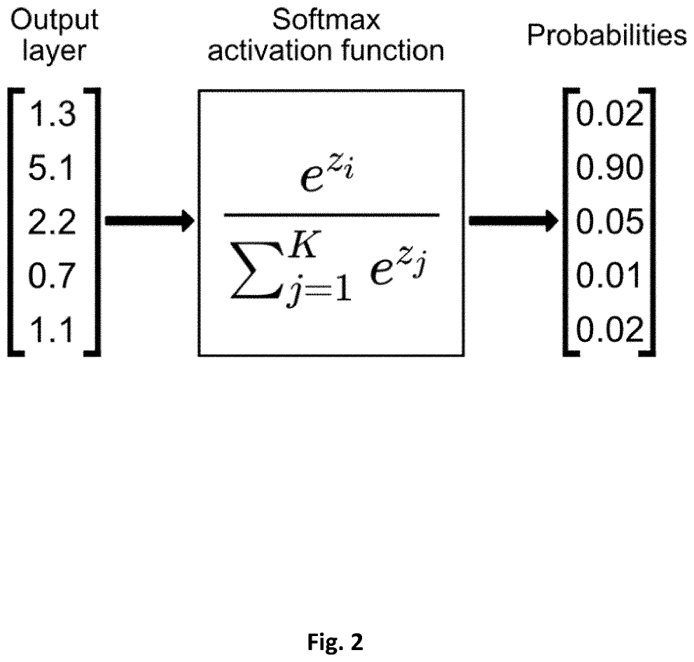

FIG. 2 is a SoftMax equation.

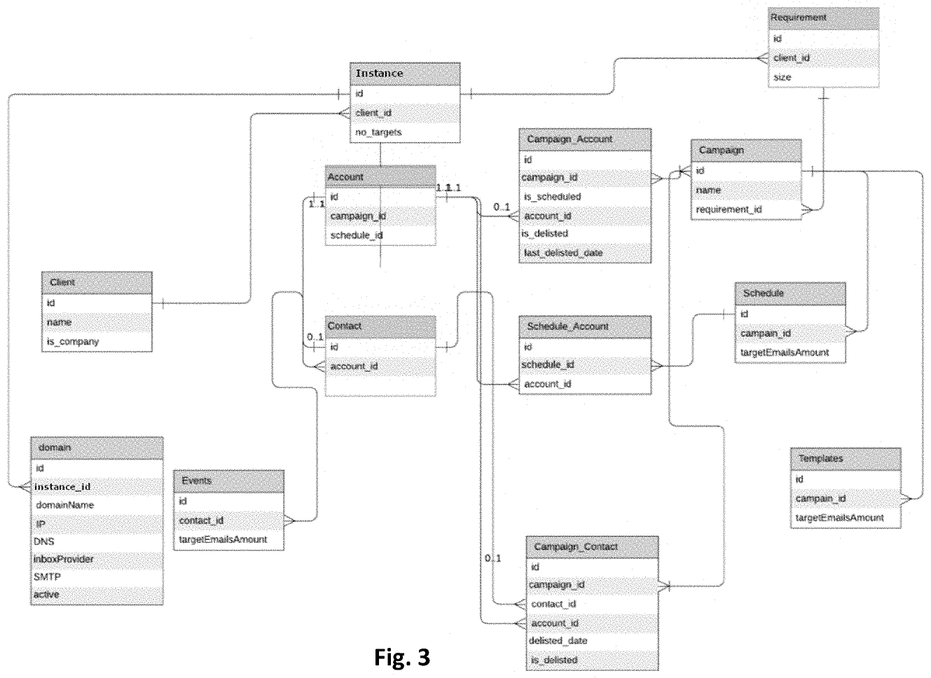

FIG. 3 is a chart depicting databases and attributes according to one embodiment of the present invention.

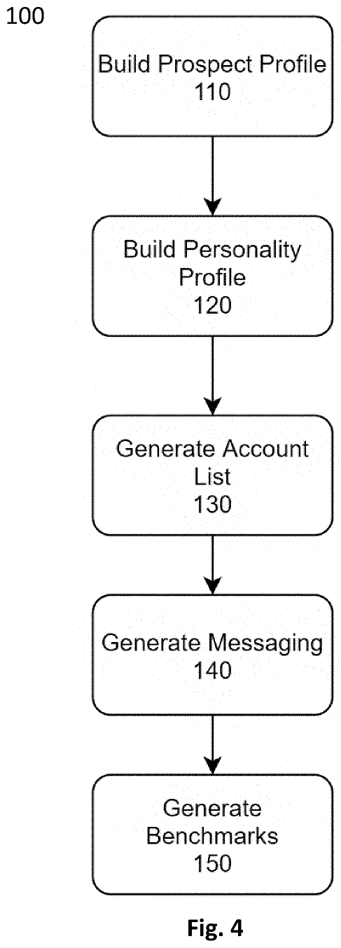

FIG. 4 is a flowchart of a deployment process according to one embodiment of the present invention.

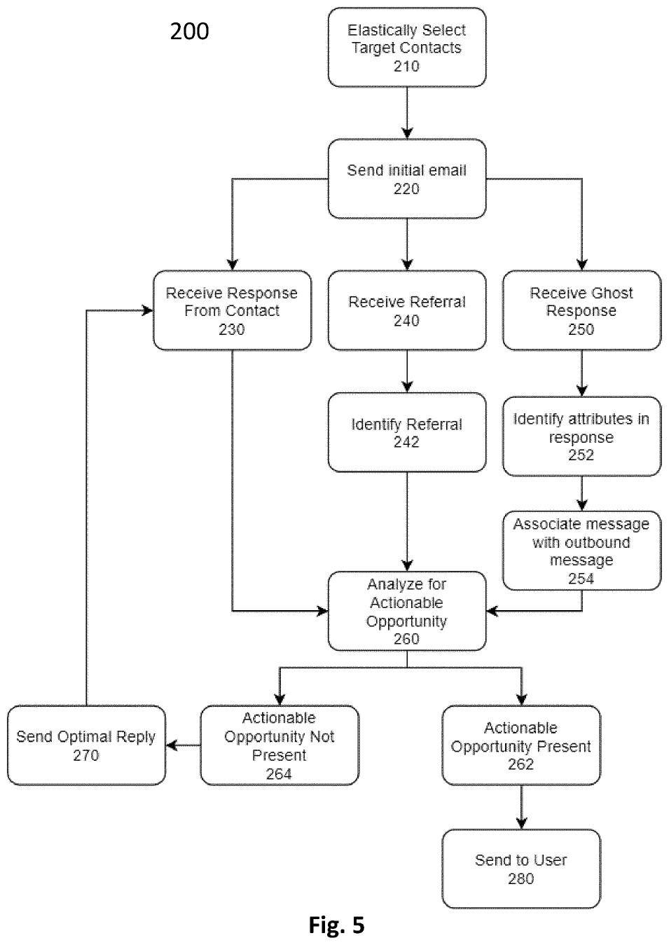

FIG. 5 is a flowchart of an engagement according to one embodiment of the present invention.

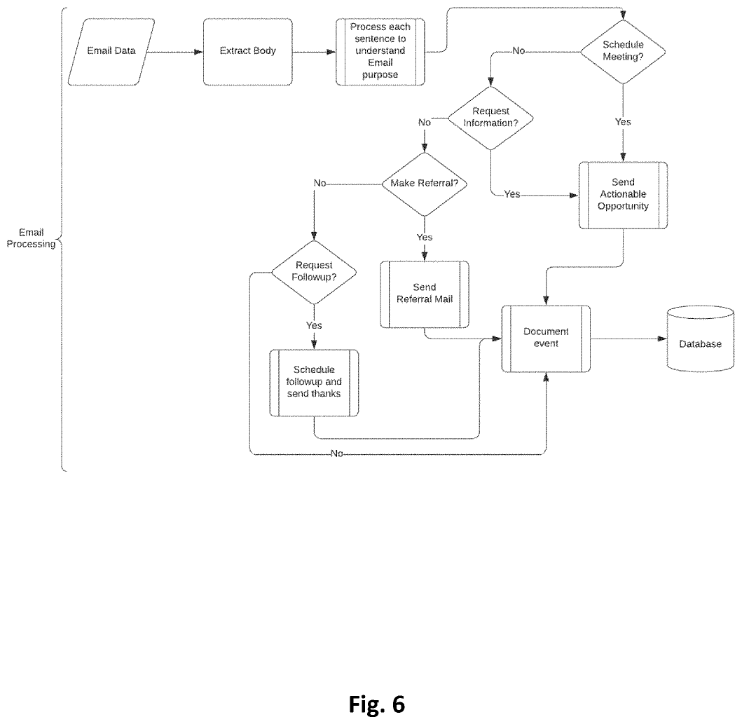

FIG. 6 is a flowchart of an email processing routine according to one embodiment of the present invention.

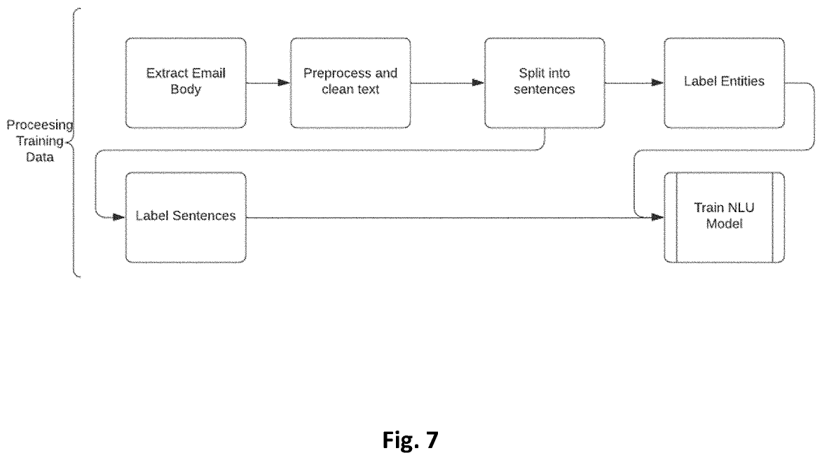

FIG. 7 is a flowchart of a training routine according to one embodiment of the present invention.

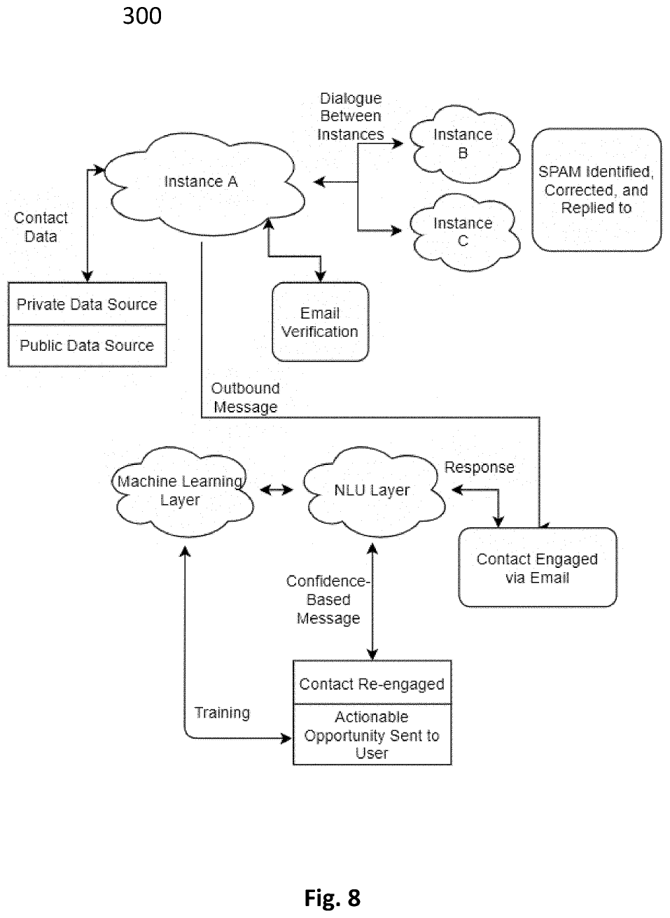

FIG. 8 is a flowchart of an engagement and delivery reliability process according to one embodiment of the present invention.

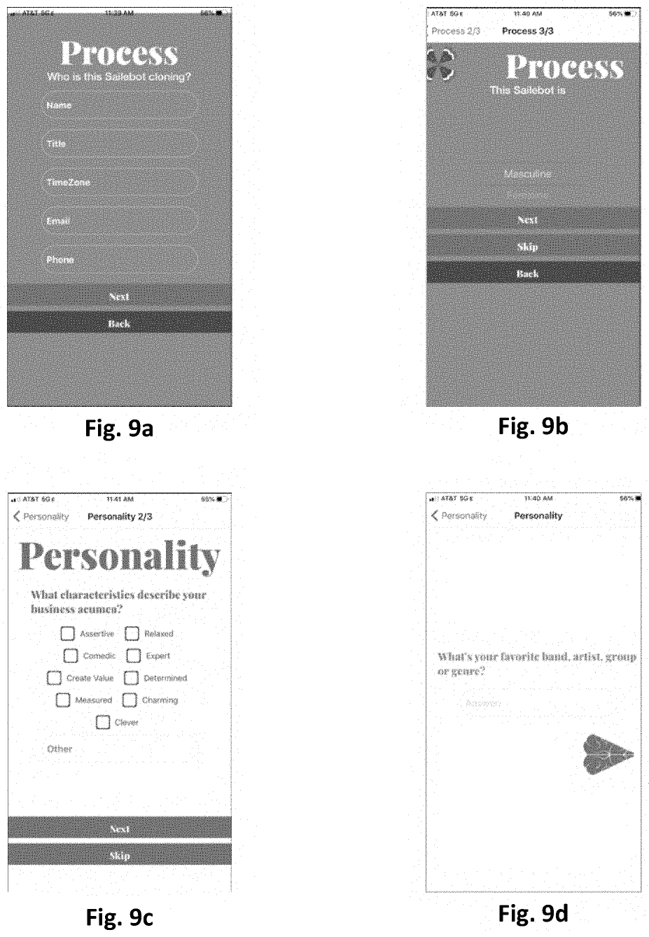

FIGS. 9a-d depict onboarding materials according to one embodiment of the present invention.

Exhibit A is a collection of information regarding the present invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

A digital labor task system and method are provided. The system, in some embodiments, includes a memory storing machine readable code. A processor is coupled to the memory, the processor capable of performing actions. Broadly, the system is configured to deploy an instance, engage in a marketing campaign, identify actionable opportunities, and notify a user of said actionable opportunities.

In deploying an instances, a copy of machine readable code is generated and transferred to a memory. Utilizing a processor and one or more database, the system is given access to an email account through a data connection. A user accesses the system via a computing device with a graphical user interface to configure the system. The system is configured to act as a sales executive during an email marketing campaign. The system utilizes the email account through the data connection to send initial emails to one or more target prospect. The initial emails appear, from the perspective of the recipient, to originate from the account of a sales executive. Typically, the sales executive is the user of the system, which is sending emails on behalf of the sales executive. The system monitors the email account through a data connection until a response is received. The system then parses the content of the email and utilizes one or more database and/or neural network to assess viability of various responses to the inbound email. This assessment is performed by a natural language understanding model which is stored in the memory and engaged by the processor. The output of the model is a confidence score relative to each potential response to the inbound email. The confidence score generated by the model is based on a trained neural network, the network being trained on prior email correspondence. The system then stores the confidence score for each potential response in memory and determines which confidence score is highest. The reply associated with this confidence score is then sent via the data connection to the target prospect, and the system once again monitors the account until a response is received. This outbound/inbound cycle repeats until the system, once again analyzing inbound emails, identifies an actionable opportunity. Upon identification of an actionable opportunity, the system compiles the entire email conversation history and forwards it to a user of the system, typically a sales executive. The sales executive is then presented with the opportunity and can continue the email conversation manually. The target prospect will see all communication as coming from the sales executive, so they will not be aware that the system handled the initial back and forth email prior to handing the conversation off to the sales executive.

Referring generally to FIG. 1, the system utilizes and/or includes one or more neural network. In some embodiments, the neural network is stored in memory accessible by one or more processor. The neural network consists of a plurality of artificial neurons, which are sometimes referred to as units. In some embodiments, each neuron, or unit, represents a mathematical function or calculation. The units are arranged in a series of layers, each of which is connected to the layers on either side of it. Some layers, typically the left most layer, are input layers and the neurons within such layers are also sometimes referred to as input units. In some embodiments, the input units are configured to receive various forms of information. In some embodiments, the information is data related to a correspondence. Some layers, typically the right most layer, are output layers and the neurons within such layers are also sometimes referred to as output units. Some layers, typically the layers between the input and output units, are hidden layers and the neurons within such layers are also sometimes referred to as hidden units. In some embodiments, the neural network includes connections between the units. In some embodiments, each hidden unit and each output unit are fully connected, such that each hidden unit and each output unit is connected to every unit in the layers on either side. In some embodiments, the connections between layers are represented by a number which is called a weight, which can be either positive (to indicate one unit excites another) or negative (to indicate one unit suppresses or inhibits another). The higher the weight, the more influences one unit has on another.

Information flows through a neural network in two ways. In some embodiments, where the neural network is being trained or when it is operating normally after training, patterns of information are fed into the network via the input units. The inputs trigger the layers of hidden units, and these in turn arrive at the output units. In some embodiments, this design is called a feedforward network. Not all units “fire” or trigger all the time. Instead, each unit receives inputs from the units to its left, and the inputs are multiplied by the weights of the connections they travel along. Every unit adds up all the inputs it receives in this way and, in some embodiments, if the sum is more than a certain unit threshold value, the unit “fires” and triggers the units it's connected to, such as those depicted on its right. In some embodiments, no unit threshold is utilized and the unit “fires” regardless of the unit's value.

In some embodiments, for a neural network to be trained, there is a feedback provided to the system. In some embodiments, the feedback process is called backpropagation, or backprop. During training, the output data the network produces is compared to the output data it was expected to produce. Utilizing the difference between the actual output data and the expected output data, the system modifies the weights of the connections between the units of the network, typically, but not necessarily, working from the output units then to the hidden units and finally to the input units. Thus, the weights of the connections between the various units are modified, reducing the difference between the actual and intended output data. This process is repeated until the actual output data and the expected output data coincide, or until the difference between them reaches an acceptable level, such as 10% or the like. In some embodiments, once the network has been trained through examples, it is at the point where it can receive a new set of inputs which the network has not been presented with and output a result.

In some embodiments, the output of a neural network is then normalized. In some embodiments, such normalization converts the data of the output nodes into a percentage. In some embodiments, the converted percentage of all the data output nodes is a probability of each value, which sums to 1. In some embodiments, the mathematical function utilized for this conversion is a SoftMax activation function, such as the one shown in FIG. 2. In some embodiments, the SoftMax activation function is a mathematical function that converts a vector of numbers (such as a vector of data from the output units) into a vector of probabilities, where the probabilities of each value are proportional to the relative scale of each value in the vector. The resulting probability vector sums to one. Each value in the output of the SoftMax function is interpreted as the probability of membership for each class, otherwise referred to as a confidence score.

Referring to FIG. 3, the system includes one or more database and data attribute. A database is configured to store a certain subset of information and therefore can be referred to a database of that subset of information. In some embodiments, such databases include, but are not limited to, a requirement database, an instance database, a domain database, a client database, an account database, a contact database, an events database, a campaign database, a campaign account database, a campaign contact database, a schedule database, a schedule account database, a template database, or the like. Each database is configured to store one or more attribute. In some embodiments, such attributes are only able to be stored in certain databases, while in yet some embodiments, such attributes are freely stored in any database. In some embodiments, such attributes include, but are not limited to, Boolean true/false values, a database id, a client id, a database size, a number of targets, a client name, a client company, instance id, a domain name, an internet protocol address, a domain name server, an inbox provider, an activity indicator, a simple main transfer protocol address, an event id, a contact id, a target number of emails, an account id, a campaign id, a schedule id, a date, a rule, a data point, and the like, such as may be discussed throughout the application.

It will be appreciated that such databases associated with the system may all be stored on one memory or on separate memories and that such separate memories may be distant from each other in physical location. The system is configured to access each database either directly through local data connection to the memory containing the database or through a remote data connection to the memory containing the database, such as an internet connection.

In some embodiments, the neural network is utilized in the identification of one or more actionable opportunity. In some embodiments, an actionable opportunity is identified based on one or more confidence score based on neural network output data based on input data derived from attributes of a communication, such as an email. In some embodiments, the system utilizes a data connection to send an outbound correspondence and then subsequently analyzes incoming communication and classifies the communication as appropriate for one or more response type via the neural network. In some embodiments, the classification is based on the sender of the communication, the content of the communication, the timing of the communication, and/or other like attributes associated with the communication, which are stored in a database. In some embodiments, the response type is an actionable opportunity. In some embodiments, the actionable opportunity is a Meeting-Ready actionable opportunity. In some embodiments, a Meeting-Ready Actionable Opportunity is a response indicating an interest or, in some embodiments, a request for a meeting, a conference call, a demonstration, or the like. In some embodiments, the actionable opportunity is a neutral actionable opportunity. In some embodiments, a Neutral Actionable Opportunity is a response indicating an interest or request for more information or indicating an interest without explicitly requesting a meeting.

In some embodiments, the system utilizes machine learning, such as the neural network, to produce confidence scores based on inputs of attributes associated with messages. In some embodiments, the machine learning model is a default model that is untrained. In some embodiments, the machine learning model is a custom model based on training. In some embodiments, the machine learning model begins as a default model, such as at the time of initial deployment, and is customized via training. In some embodiments, such machine learning enables natural-language processing, such as natural-language understanding (NLU) functionality. In some embodiments, the NLU functionality is trained by inputting correspondence and backpropagating to establishes weights for the connections. In some embodiments, the system utilizes NLU functionality to assess and categorize responses, such as assessing the attributes of an email correspondence to determine an appropriate response.

Referring generally to FIG. 4, in some embodiments, the system and method include deployment 100 of an instance to a first memory. In some embodiments, an instance is a single copy of the machine-readable code stored on the memory and accessible by a processor. In some embodiments, deployment 100 of said instance is achieved by coping machine-readable-code from a first memory to a second memory. In some embodiments, an instance is a new context based on an initial model, prior to training of said model, such as an untrained neural network. In some embodiments, an instance is initially deployed in a stock configuration based on a neural network machine leaning model. In some embodiments, each instance is separate from and unable to communicate with another instance. In some embodiments, instances are configured to communicate with each other, such as by email or other electronic communication. In some embodiments, deployment of an instance generates a copy of machine-readable code and stores that code on a memory coupled to a processor, such as a server. In some embodiments, the instance is given or otherwise includes an addressable account or address, such as an email address. In some embodiments, one or more attributes of the instance and/or a user are stored within a database accessible by the system and/or the instance. In some embodiments, the instance receives one or more communication associated with the address, such as an email.

In some embodiments, the deployment of an instance includes building a first profile. In some embodiments, said profile includes one or more attributes. In some embodiments, said profile is a profile database. In some embodiments, the profile is a prospect profile 110. In some embodiments, the prospect profile 110 includes attributes associated with targets for a campaign, such as an email marketing campaign. In some embodiments, the attributes are established through an onboarding process and stored in one or more database. Referring generally to FIGS. 9a-d, in some embodiments, the onboarding process includes the completion of written materials, such as surveys, questionnaires, goals, value propositions, and the like by a user of the system and ingestion of said materials into the system, such as via storage within a memory of the system and/or within a database of the system. In some embodiments, the onboarding process includes an oral interview, while in some embodiments the onboarding process includes defining key attributes. In some embodiments, the onboarding process utilizes the aforementioned processes, along with similar onboarding processes. In some embodiments, a prospect profile 110 is generated based on the onboarding process. In some embodiments, said prospect profile is stored in a database.

In some embodiments, the deployment of an instance includes building a second profile. In some embodiments, said profile includes one or more attributes. In some embodiments, said profile is a profile database. In some embodiments, the profile is a personality profile 120. The personality profile 120 is configured to respond to incoming correspondence in a certain manner, for example, a more assertive personality profile 120 will respond with a more aggressive value proposition, while a less assertive personality profile 120 will respond with a softer touch. In some embodiments, the personality profile 120 is based on a multitude of personality traits, such as assertiveness, friendliness, tone, formality of language, exuberance, and the like, such as shown in FIG. 9d.

In some embodiments, the personality profile 120 is built manually by identifying attributes and storing said attributes within a database. The personality profile comprises attributes of personality traits and mannerisms which impact the style and flow of an email correspondence. In some embodiments, the personality profile is configured to mimic the email correspondence of a user of the system, such as a sales executive. In some embodiments, attributes of a personality profile are utilized as inputs to a neural network to generate a confidence score. In some embodiments, one or more onboarding materials are utilized to build the personality profile 120, such as shown in FIGS. 9a-d. In some embodiments, such onboarding materials are quizzes, interviews, personality profiling tests, and the like. In some embodiments, the responses to the onboarding materials are utilized to build a personality profile 120, which are stored as defined attributes within one or more database. In some embodiments, a user manually selects desired attributes for personality traits of the personality profile 120 and the system add the desired attributes to one or more database. In some embodiments, the personality profile 120 includes defined rules for the instance, such as total number of outreaches for a particular target, an ideal length of response, a maximum length of response, a minimum length of response, formality of language used for response, tone for the response, scheduling rules for response (i.e. not to respond at certain times, always respond within a certain timeframe after receiving a response, sending responses only a certain times, and the like), and the like. In some embodiments, each rule is an attribute store within one or more database, such as a rule database.

In some embodiments, the personality profile 120 is built automatically. In some embodiments, automatic personality profiling mimics the relevant personality characteristics and attributes of a system user through training a neural network. In some embodiments, the system user is a sales executive. In some embodiments, the sales executive is engaged in his or her normal sales activity via email. During this normal activity, the sales executive sends, either by copying or by forwarding, all correspondence to the address of the deployed instance. The deployed instance receives the correspondence, such as email correspondence received in an email inbox. In some embodiments, the system then assesses the system user's writing and correspondence for various relevant personality characteristics and traits. In some embodiments, certain aspects of the one or more correspondence are input as attributes into a database, such as the length of a message, the formality of a language, the tone, and the like. In some embodiments, the assessment is performed utilizing the NLU model deployed with the instance. In some embodiments, the assessment is performed by a trained neural network. In some embodiments, the assessment is the training of the neural network. In some embodiments, the NLU model is updated through neural network machine learning as the instance assesses the correspondence. In some embodiments, through this NLU assessment and subsequent reinforcement based on expected vs actual responses by the system user, the NLU model develops a personality profile 120 by training the neural network. In some embodiments, one or more additional rule is added to the generated personality profile 120, such as total number of outreaches for a particular target, an ideal length of response, a maximum length of response, a minimum length of response, formality of language used for response, tone for the response, scheduling rules for response (i.e. not to respond at certain times, always respond within a certain timeframe after receiving a response, sending responses only a certain times, and the like), and the like. These rules serve as additional input data for the neural network to train and to generate a confidence score.

In some embodiments, the personality profile 120 is configured to be modified after it is built. In some embodiments, such modification is performed by changing one or more attribute stored in one or more database of the system. In some embodiments, the modification is performed by a user through a guided user interface. In some embodiments, the modification is capable of being implemented after the personality profile 120 is built manually or automatically. In some embodiments, modification of the personality profile 120 adjusts and/or adds one or more rules, such as total number of outreaches for a particular target, an ideal length of response, a maximum length of response, a minimum length of response, formality of language used for response, tone for the response, scheduling rules for response (i.e. not to respond at certain times, always respond within a certain timeframe after receiving a response, sending responses only a certain times, and the like), and the like. In some embodiments, modification of the personality profile 120 adjust one or more personality traits and/or characteristics, such as assertiveness, friendliness, tone, formality of language, exuberance, and the like. In this way, the system is configured to optimize personality profiles, even those that mimic real-world system users. For example, a sales executive with excellent tone and formal language skills may not have an assertive personality. The system automatically mimics the personality of the sales executive, which is then later modified to be more assertive, thus generating more favorable opportunities for the user. In this way, the system enhances or otherwise augments the characteristics of a system user in a manner which the system user cannot reliably achieve. Moreover, the personality profile 120 is customizable and/or modified for particular target prospects, allowing for a user to tailor a personality profile to each individual target for more favorable opportunities. Thus, the system provides for augmentation of personality profiles in a structured manner to produce more favorable outcomes. In utilizing the neural network, the system can be trained to mimic and/or augment the written personality of a user, such as a sales executive.

In some embodiments, once a personality profile 120 is built, the profile continues to optimize. In some embodiments, the optimization occurs through a similar process as training, where a system user sends the instance correspondence, which the system ingests as attributes and analyzes through the neural network. In some embodiments, the system continuously tests different potential responses in a virtual environment, such as a separate training of a copy of the active neural network, and tests those against the actual response given by the system user. In some embodiments, the system uses both the tested virtual responses, a confidence score associated with the virtual responses, and the actual response given by the system user to further refine the neural network machine learning model for NLU. In some embodiments, when the system verifies a more optimal model of the neural network has been generated by the machine learning processes, the existing NLU model is replaced by the optimal model. Advantageously, this process occurs during the normal course of interactions and communications by the system user, allowing the system to optimize and generate more favorable outcomes without direct user involvement and without interruption to the system.

In some embodiments, the deployment 100 of an instance includes generating an account list 130 and/or account list database. In some embodiments, the account list 130 is a list of potential targets to which communications from the inventive system are to be sent. In some embodiments, the account list is generated based at least partially on at least one profile. In some embodiments, the profile is a prospect profile 110. In some embodiments, one or more attributes of the prospect profile 110 are compared against a pre-defined contact list, such as a contact database. In some embodiments, such comparison identifies ideal target prospects for inclusion in the account list. In some embodiments, the ideal target prospects make up the entirety of the target prospects for the account list, while in other embodiments a user-identified set of target prospects are included in the list. In some embodiments, the target prospects are all user-identified. In some embodiments, target prospects are selected based on one or more attribute, such as target size, revenue, industry, and other similar business attributes. In some embodiments, user-specific goals, such as specific value propositions, target industries, and target demographics, are utilized in identifying a target prospect list. In some embodiments, upon finalizing a target prospect list, the system associates one or more contacts with each of the target prospects. In some embodiments, the contacts include one or more contact data, such as name, position, employer, email address, phone number, and the like. In some embodiments, the contact data is acquired from public sources, such as social media accounts, business web pages, directories, and the like. In some embodiments, the contact data originates from private sources, such as compiled databases. In some embodiments, the contact data is an aggregate of both public and private sources. In some embodiments, upon receiving the contact data, the system validates the data. In some embodiments, such validation checks if the listed email address is still valid and able to receive correspondence, such as by verifying syntax, checking against lists of known invalid emails, checking for obvious typos, domain name service lookups, email box pinging, third-party validation services, or the like. In some embodiments, valid contacts are stored in a database, such as a contact database.

In some embodiments, the deployment 100 of an instance includes generating messaging 140 and messaging templates. In some embodiments, such templates are stored in a template database. In some embodiments, messaging is generated based on one or more messaging factors. In some embodiments, such messaging factors are prospect attributes, value propositions, user goals, personality profiles, and the like. In some embodiments, the messaging factors are stored in a database, such as a factor database. In some embodiments, one or more message templates are generated. The message templates serve as ‘shell’ responses into which the system dynamically inserts attributes from one or more database to complete the response. In some embodiments, the message templates are similar in tactics, tone, length, and/or call to action. In some embodiments, the message templates differ in tactics, tone, length, and/or call to action. Thus, the templates themselves, in some embodiments, have one or more attribute associated with them, such attributes stored in a database. In some embodiments, one or more of the message templates includes an invitation for an actionable opportunity, such as an invitation for a call, meeting, or the like. In some embodiments, the message templates are configured such that the system selectively inserts one or more contact data into specific locations in the template, such as placing a contact name into a field in the template designated for the name. In some embodiments, the templates are the target and/or benchmark goal of the neural network output.

In some embodiments, the deployment 100 of an instance includes generating benchmark goals 150. In some embodiments, the benchmark goals 150 are those which the system trains the NLU model to optimize. In some embodiments, the goals are business goals, such as a goal number of actionable opportunities, a goal number of digital labor tasks, or the like. In some embodiments, the goals are a total goal, while in other embodiments the goals are for a specific time period. In some embodiments, the goals are stored in one or more database.

In some embodiments, the deployment of an instance includes initially training an NLU model. In some embodiments, the system utilizes one or more database and one or more attributes associated with each database, such as those associated with a prospect profile 110, a personality profile 120, an account list 130, generated messaging 140, and/or benchmark goals 150 to train a neural network machine learning model. In some embodiments, the training of the NLU model is done after the generation of a personality profile, while in other embodiments the training of the NLU model is done while generating a personality profile, while in yet other embodiments the training of the NLU model is done prior to generating a personality profile. In this way, the personality profile, its database, and its attributes are either ‘baked in’ to the neural network weighting or they are themselves part of the input data for the neural network.

In some embodiments, the system is provided with one or more correspondence from a system user. In some embodiments, the system ingests and analyses the correspondence, such as by identifying one or more attribute associated with the correspondence and storing said attributes within a database. In some embodiments, the correspondence is a reply to a system user outgoing message. In some embodiments, the system applies one or more attribute associated with the database and, where necessary, one or more attributes associated with one or more other database of the system as inputs to the NLU model, which is configured to generate a confidence score indicating an advantageous reply option. In some embodiments, the reply option is one or more of the generated messages. In some embodiments, the NLU model generates one or more confidence scores associated with the one or more generated message. In some embodiments, the confidence score for each of the one or more generated messages is compared against a pre-determined threshold value. In some embodiments, the threshold value is 90% confidence, but it will be appreciated that the system is configured to support a full range of threshold values, from 0% to 100% confidence.

In some embodiments, where the confidence score for at least one of the generated messages is above the threshold value, the system identifies the highest confidence response option as the advantageous reply option. In some embodiments, during training, this advantageous reply option is set as a benchmark reply for training the NLU model. In some embodiments, the system then ingests and analyzes the actual reply from the system user, which is compared against the benchmark reply. In some embodiments, the benchmark reply is of the same type as the actual reply and the model adjusts the neural network connections through backpropagation which produced the selection of the benchmark reply, training the model. In some embodiments, the benchmark reply is not of the same type as the actual reply and the model adjusts the neural network connections through backpropagation with produced the selection of the benchmark reply, training the model.

In some embodiments, where the confidence score for at least one of the generated messages is below the threshold value, the system does not train based on a benchmark reply. In some embodiments, the system then ingests and analyzes the actual reply from the system user. In some embodiments, the type of the actual reply is associated with one or more generated messages and the machine learning model generates multiple pseudo-random simulations of generations of benchmark replies within a virtual environment, backpropagating as appropriate utilizing the actual reply as the expected output data, training the model. In some embodiments, the virtual environment model becomes more optimized than the deployed model, which is verified by the difference in actual output of the model and expected output. When the virtual model becomes more optimized, the system copies the optimized model into memory and replaces the previously deployed model with the virtual model, which then becomes the newly deployed model.

In some embodiments, the initial model training process repeats for each correspondence provided by a system user. In some embodiments, the initial model training process continues prior to engaging a campaign until the system produces a reply option with an associated confidence score above the target threshold for a pre-determined ratio of replies. In some embodiments, the initial model training continues for a set duration of time.

Referring generally to FIG. 5, in some embodiments, upon completion of initial model training, the system engages a campaign. In some embodiments, a campaign is generally a marketing campaign on the behalf of a user or a group of users. In some embodiments, a campaign begins by elastically choosing target contacts 210 for each target prospect. As the system likely includes multiple potential contacts for each target prospect, it is often detrimental to send marketing materials to all potential contacts. In some embodiments, the system ingests attributes of potential contacts and the associated target prospects and selects target contacts which have a high likelihood for success and stores those attributes in a database. In some embodiments, the system determines the likelihood of success for target contacts based on NLU model reinforcement during training. In some embodiments, such determination is based one or more attribute associated with the target contact, while in yet some more embodiments the determination is made based on prior interactions of the system with the target contact, either through the present instance and/or through a separate instance. In some embodiments, the system further assesses the email addresses associated with the target contacts associated with each target prospect and discards a pre-determined portion of contacts based on attributes associated with the target contacts. In some embodiments, the selection of contacts is based on a pre-defined number. In some embodiments, the pre-defined number identifies an average number of target contacts per target prospects. The system utilizes a ranked database of desired attributes to compare against contact attributes and calculates an optimized set of desired target contacts which meets the pre-defined average of targets per contact. This, in some embodiments, results in different target prospects having different numbers of target clients. For example, if the pre-defined number is 4, one target prospect may have 6 clients selected, while another may have only 2, averaging out to 4.

In some embodiments, engaging a campaign 200 includes a standard engagement routine. In some embodiments, a standard engagement routine includes the system sending an email 220 via an email provider over a data connection to one or more target prospect and/or one or more target contacts associated with said target prospect. In some embodiments, the system monitors for a response 230 from one or more target contact, such as by periodically checking the folders of the email provider. In some embodiments, upon receiving a response, the system ingests and analyzes the received response 260. In some embodiments, various attributes of the response are stored in one or more database, such as length, sender, time, tone, and the like. In some embodiments, such analysis includes applying the deployed and/or trained NLU model by inputting one or more attribute from one or more database and generating a confidence score. In some embodiments, the system determines an optimal response 270, where in some embodiments such optimal response is a message template and/or identification of an actionable opportunity which receives the highest confidence score above a threshold value based on the NLU model. In some embodiments, where the highest confidence score is not the identification of an actionable opportunity, the system populates the message template with information and attributes from one or more database related to the target contact, such as name, position, and the like. In some embodiments, one or more additional rule is applied to the response criteria in determining which response is optimal. In some embodiments, once the template is populated with the attributes, the message is sent as a response to the target contact. In some embodiments, the system proceeds to repeat the cycle of send, receive, analyze, optimize, send until either an actionable opportunity 260, 262 is identified or until a target threshold is met, such as a predefined maximum number of digital tasks. In some embodiments, upon identification of an actionable opportunity, the system notifies one or more user of the system of the actionable opportunity 280 and provides a summary of the interactions the system undertook with the target contact.

In some embodiments, a campaign 200 includes a referral engagement routine. In some embodiments, a referral engagement routine includes the system sending an email 220 to one or more target prospect and/or one or more target contacts 210 associated with said target prospect. In some embodiments, the system monitors for a response from one or more target contact. In some embodiments, the response includes information which refers the initial value proposition and/or correspondence to a non-target individual 240. In some embodiments, the system analyzes the response utilizing NLU model to identify that a referral has occurred and to further parse relevant attributes of the non-target individual, such as name, email address, phone number, position, and the like 242. In some embodiments, upon identifying the referral the system determines an optimal response to send to the non-target individual 260, 264, 270. In some embodiments, the non-target individual becomes the new target contact for the engagement routine. In some embodiments, the system accesses and stores the contact data in a database, and such replacement is performed by replacing the target contact information in said database. In some embodiments, the response is a message template for non-target individuals. In some embodiments, the system populates the message template with information related to the new target contact, such as name, position, and the like. The system then proceeds as in the standard engagement routine, additionally copying the original target contact on at least part of the future correspondence. In some embodiments, the system proceeds to repeat the cycle of send, receive, analyze, optimize, send until either an actionable opportunity 260, 262 is identified or until a target threshold is met, such as a predefined maximum number of digital tasks. In some embodiments, upon identification of an actionable opportunity, the system notifies one or more user of the system of the actionable opportunity 280 and provides a summary of the interactions the system undertook with the target contact and non-target individual.

In some embodiments, a campaign 200 includes a ghost engagement routine. In some embodiments, a ghost engagement routine includes the system sending an email 220 to one or more target prospect and/or one or more target contacts 210 associated with said target prospect. In some embodiments, the system monitors for a response from one or more target contact. In some embodiments, a response is instead received from a non-target individual, without copying the original target contact. In some embodiments, such a response is considered a ghost response 250. In some embodiments, the system utilizes an NLU model to identify certain features of the ghost response to associate it with an active campaign and/or the initial target contact 252, 254. In some embodiments, such features are identification of a name, email address, phone number, company, position, or the like. In some embodiments, the system associates the ghost message with the initial outbound message, while in other embodiments the system does not make such an association. In some embodiments, the system reassigns the non-target individual as the new target contact and proceeds as in the standard engagement routine 260. In some embodiments, the system proceeds to repeat the cycle of send, receive, analyze, optimize, send until either an actionable opportunity 260, 262 is identified or until a target threshold is met, such as a predefined maximum number of digital tasks. In some embodiments, upon identification of an actionable opportunity, the system notifies one or more user of the system of the actionable opportunity 280 and provides a summary of the interactions the system undertook with the target contact, where identified, and non-target individual.

Referring generally to FIG. 6, the system includes one or more routine for processing email replies. In some embodiments, an email is received by a mailbox associated with the system. Via a data connection, the system intakes the email data and stores it to one or more database. The email data includes one or more attributes associated with the email, such as the body of the email, its sender, the time it was sent, its position and/or number in the order of correspondence, and the like. In some embodiments, the system parses through the body of the message and splits that data into one or more data type. In some embodiments, the message is split into sentences and stored in a database. In some embodiments, each sentence is classified according to one or more attribute, such as by keywords, the length of the sentence, its relative position in the message, and the like. In some embodiments, the sentences, the classifications, and/or other attributes of the email are utilized as the input to activate and/or train the NLU model.

In some embodiments, the NLU model produces an output which generates a confidence score on if the email purpose was to schedule a meeting and/or request information. In some embodiments, where the email purpose is identified as to schedule a meeting and/or request information, the system notifies a user of the system, typically through an email. In some embodiments, the notification is an actionable opportunity.

In some embodiments, the NLU model produces an output which generates a confidence score on if a referral was made within the email. In some embodiments, where a referral was made, the system stores the referral information within a database and utilizes the referral information, such as referral name and email address, to generate a response to the referral. In some embodiments, the response utilizes a template message from one or more template database. In some embodiments, upon sending the referral response, the system monitors the inbox for a response.

In some embodiments, the NLU model produces an output which generates a confidence score on if a follow-up was requested. In some embodiments, where a follow-up was requested, the system schedules a follow-up. In some embodiments, the follow up is one or more rule regarding sending of another email to the same contact, such as a rule to send a follow up email on a certain date or after a certain period of time. In some embodiments, the follow up rule and/or scheduled time are stored in one or more database. In some embodiments, the database is a rules database which defines system actions relative to follow-ups.

In some embodiments, upon assessment of an email, the system stores to NLU output, the message attributes, and all data requests in one or more database such as to create a log of the events. In some embodiments, each event or action of the system is referred to as a digital labor task. In some embodiments, the system is configured, through one or more rule, to perform a set number of digital labor tasks, either for a specific user of the system or in correspondence with a target prospect and/or target client.

Referring generally to FIG. 8, in some embodiments, the system includes a deliverability routine. In some embodiments, prior to or during the engagement of a campaign, a first instance of the system is in communication with one or more additional instance of the system. In some embodiments, the first instance sends an outbound message to one or more additional instance. The additional instance receives said message within a folder of an email management suite, such as an inbox or spam folder. The additional instance scans its spam folder to check if the message was placed in the spam folder by filters utilized by the email hosting suite. In some embodiments, the message is placed in spam. In such embodiments, the system reports the message as not being spam. In some embodiments, the system marks the message as important. In some embodiments, the system then responds to the message with a pre-determined message, sending the message to the first instance. The first instance receives said response within a folder of an email management suite, such as an inbox or spam folder. The first instance scans its spam folder to check if the response was placed in the spam folder by filters utilized by the email hosting suite. In some embodiments, the response is placed in spam. In such embodiments, the system reports the response as not being spam. In some embodiments, the system marks the response as important. In some embodiments, the system then responds to the message with a pre-determined message, sending the message to the additional instance. In some embodiments, the deliverability routine continues this back-and-forth response cycle with the one or more additional instance for a set duration. In some embodiments, the cycle continues indefinitely. In some embodiments, such process trains the email management suite's spam filter to not identify messages from the various instances as spam, thus improving deliverability of the messages to target contacts.

In some embodiments, one or more instance is in data communication with one or more other instance. Such data connection is facilitated over the internet, according to some embodiments. In some embodiments, the instances share information regarding one or more attribute and/or one or more engagement routine. In some embodiments, one instance informs a separate instance of successful engagements and the identified replies, such that other instances can utilize similar replies to maximize generation of actionable opportunities. In some embodiments, one instance shares NLU model improvements to one or more additional instance, improving the confidence scores of the receiving instances.

Various embodiments of the computer program, system, and method of embodiments of the present invention are implemented in hardware, software, firmware, or combinations thereof using the digital labor task system, which broadly comprises server devices, computing devices, and a communications network. Various embodiments of the server devices include computing devices that provide access to one or more general computing resources, such as Internet services, electronic mail services, data transfer services, and the like. In some embodiments the server devices also provides access to a database that stores information and data, with such information and data including, without limitation, account information, NLU model information, campaign information, personality information, or other information and data necessary and/or desirable for the implementation of the computer program, system, and method of the present invention, as will be discussed in more detail below.

Various embodiments of the server devices and the computing devices include any device, component, or equipment with a processing element and associated memory elements. In some embodiments the processing element implements operating systems, and in some such embodiments is capable of executing the computer program, which is also generally known as instructions, commands, software code, executables, applications (apps), and the like. In some embodiments the processing element includes processors, microprocessors, microcontrollers, field programmable gate arrays, and the like, or combinations thereof In some embodiments the memory elements are capable of storing or retaining the computer program and in some such embodiments also store data, typically binary data, including text, databases, graphics, audio, video, combinations thereof, and the like. In some embodiments the memory elements also are known as a “computer-readable storage medium” and in some such embodiments include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, in some embodiments the server devices further include file stores comprising a plurality of hard disk drives, network attached storage, or a separate storage network.

Various embodiments of the computing devices specifically include mobile communication devices (including wireless devices), work stations, desktop computers, laptop computers, palmtop computers, tablet computers, portable digital assistants (PDA), smart phones, wearable devices and the like, or combinations thereof. Various embodiments of the computing devices also include voice communication devices, such as cell phones or landline phones. In some preferred embodiments, the computing device has an electronic display, such as a cathode ray tube, liquid crystal display, plasma, or touch screen that is operable to display visual graphics, images, text, etc. In certain embodiments, the computer program of the present invention facilitates interaction and communication through a graphical user interface (GUI) that is displayed via the electronic display. The GUI enables the user to interact with the electronic display by touching or pointing at display areas to provide information to the user control interface, which is discussed in more detail below. In additional preferred embodiments, the computing device includes an optical device such as a digital camera, video camera, optical scanner, or the like, such that the computing device can capture, store, and transmit digital images and/or videos.

In some embodiments the computing devices includes a user control interface that enables one or more users to share information and commands with the computing devices or server devices. In some embodiments, the user interface facilitates interaction through the GUI described above or, in other embodiments comprises one or more functionable inputs such as buttons, keyboard, switches, scrolls wheels, voice recognition elements such as a microphone, pointing devices such as mice, touchpads, tracking balls, styluses. Embodiments of the user control interface also include a speaker for providing audible instructions and feedback. Further, embodiments of the user control interface comprise wired or wireless data transfer elements, such as a communication component, removable memory, data transceivers, and/or transmitters, to enable the user and/or other computing devices to remotely interface with the computing device.

In various embodiments the communications network will be wired, wireless, and/or a combination thereof, and in various embodiments will include servers, routers, switches, wireless receivers and transmitters, and the like, as well as electrically conductive cables or optical cables. In various embodiments the communications network will also include local, metro, or wide area networks, as well as the Internet, or other cloud networks. Furthermore, some embodiments of the communications network include cellular or mobile phone networks, as well as landline phone networks, public switched telephone networks, fiber optic networks, or the like.

Various embodiments of both the server devices and the computing devices are connected to the communications network. In some embodiments server devices communicate with other server devices or computing devices through the communications network. Likewise, in some embodiments, the computing devices communicate with other computing devices or server devices through the communications network. In various embodiments, the connection to the communications network will be wired, wireless, and/or a combination thereof. Thus, the server devices and the computing devices will include the appropriate components to establish a wired or a wireless connection.

Various embodiments of the computer program of the present invention run on computing devices. In other embodiments the computer program runs on one or more server devices. Additionally, in some embodiments a first portion of the program, code, or instructions execute on a first server device or a first computing device, while a second portion of the program, code, or instructions execute on a second server device or a second computing device. In some embodiments, other portions of the program, code, or instructions execute on other server devices 12 as well. For example, in some embodiments information is stored on a memory element associated with the server device, such that the information is remotely accessible to users of the computer program via one or more computing devices. Alternatively, in other embodiments the information is directly stored on the memory element associated with the one or more computing devices of the user. In additional embodiments of the present invention, a portion of the information is stored on the server device, while another portion is stored on the one or more computing devices. It will be appreciated that in some embodiments the various actions and calculations described herein as being performed by or using the computer program will actually be performed by one or more computers, processors, or other computational devices, such as the computing devices and/or server devices, independently or cooperatively executing portions of the computer program.

A user is capable of accessing various embodiments of the present invention via an electronic resource, such as an application, a mobile “app,” or a website. In certain embodiments, portions of the computer program are embodied in a stand-alone program downloadable to a user's computing device or in a web-accessible program that is accessible by the user's computing device via the network. For some embodiments of the stand-alone program, a downloadable version of the computer program is stored, at least in part, on the server device. A user downloads at least a portion of the computer program onto the computing device via the network. After the computer program has been downloaded, the program is installed on the computing device in an executable format. For some embodiments of the web-accessible computer program, the user will simply access the computer program via the network (e.g., the Internet) with the computing device.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A system for generating leads, the system comprising:
a memory for storing machine readable code; and
a processor operatively coupled to the memory, the processor configured to:
build a personality profile,
deploy an outgoing message,
receive an incoming message and analyze said incoming message to generate a confidence score, and
determine an optimal response, said determination based at least partly on said confidence score.

2. The system of claim 1, wherein said confidence score is produced at least in part by a natural language understanding model, said model trained on email correspondence from a system user.

3. The system of claim 2, wherein said confidence score is based at least in part on said personality profile.

4. The system of claim 1, further configured to:
assign a confidence score to each of a plurality of response templates,
wherein the optimal response is determined by the response template with the highest confidence score.

5. The system of claim 4, further configured to compare each confidence score against a confidence score threshold.

6. The system of claim 1, further configured to:
determine that an actionable opportunity is present in the incoming message based on said confidence score; and
notify a user that an actionable opportunity is present, said notification containing the outgoing message and the incoming message.

7. The system of claim 1, wherein said personality profile is modeled after one or more attribute of a system user.

8. The system of claim 7, wherein said personality profile is built by ingesting and analyzing one or more correspondence associated with the system user utilizing a natural language understanding model.

9. The system of claim 8, wherein said personality profile is configured for manual adjustment of one or more attribute.

10. A method of lead generation, the method comprising:
building a personality profile;
deploying an outgoing message;
receiving an incoming message and analyzing said first incoming message to generate a confidence score; and
determining an optimal response, said determination based at least partly on said confidence score.

11. The method of claim 10, wherein said confidence score is produced at least in party by a natural language understanding model, said model trained on email correspondence from a system user.

12. The method of claim 11, wherein said confidence score is based at least in part on said personality profile.

13. The method of claim 10, further comprising:
generating a plurality of response templates; and
assigning a confidence score to each response template,
wherein the optimal response is determined by the response template with the highest confidence score.

14. The method of claim 13, further comprising the step of comparing each confidence score against a confidence score threshold.

15. The method of claim 10, further comprising:
determining that an actionable opportunity is present in the incoming message based on said confidence score; and
notifying a user that an actionable opportunity is present, said notification containing the outgoing message and the incoming message.

16. The method of claim 10, wherein said personality profile is modeled after one or more attribute of a system user.

17. The method of claim 16, wherein said personality profile is built by ingesting and analyzing one or more correspondence associated with the system user utilizing a natural language understanding model.

18. The method of claim 17, further comprising the step of manually modifying said personality profile to adjust one or more attribute.

19. A method of increasing delivery for a lead generation system, the method comprising:
deploying a first instance of the system;
sending a correspondence to a second instance of the system;
receiving said correspondence by said second instance;
marking said correspondence as important;
replying to said correspondence by said second instance.

20. The method of claim 19, wherein said correspondence is received by said second instance initially marked as spam.
